(19) United States
(12) Patent Application Publication
(10) Pub. No.: US 2023/0294540 A1
(43) Pub. Date: Sep. 21, 2023

(54) PROPANE FUELED MOBILE/PORTABLE HIGH-CAPACITY EV CHARGING STATIONS

(71) Applicant: PIONEER POWER SOLUTIONS, INC., Fort Lee, NJ (US)

(72) Inventor: Nathan J. Mazurek, Fort Lee, NJ (US)

(73) Assignee: PIONEER POWER SOLUTIONS, INC., Fort Lee, NJ (US)

(21) Appl. No.: 18/122,422

(22) Filed: Mar. 16, 2023

Related U.S. Application Data
(60) Provisional application No. 63/320,857, filed on Mar. 17, 2022.

(51) Int. Cl. B60L 53/51; B60L 53/53; B60L 53/57; B60L 53/68

(52) U.S. Cl. CPC B60L 53/51; B60L 53/53; B60L 53/57; B60L 53/68; G01F 23/296

(57) ABSTRACT

The present invention provides a charging system for a mobile and portable high-capacity Electrical Vehicle (EV) charging station. The charging system comprises a plurality of propane tanks for generating power, a generator, an EV charger, a voltage selector switch, a plurality of solar panels for charging on-board batteries due to parasitic loads, a communication backhaul, a security device, and a diagnostics and monitoring device for monitoring the plurality of tanks, the generator, and the EV charger. The charging system of the present invention are configured to be used in different platforms—for example, skid integrated, truck mounted, trailing integrated, and in a pod.

### CROSS-REFERENCE TO RELATED APPLICATIONS

This application claims priority to U.S. Patent Application No. 63/320,857 filed Mar. 17, 2022, and the content of the aforementioned application is incorporated herein by reference in their entirety.

### FIELD OF THE INVENTION

The present invention relates to a novel mobile and portable high-capacity Electrical Vehicle (EV) charging station. In particular, the present invention relates to various EV charging solutions that are capable of providing portable, sustainable, propane-powered, charging solutions for EVs while minimizing carbon emissions as much as possible.

### BACKGROUND OF THE INVENTION

As EV adoption grows, utilities and other power generators must grapple with the issue of determining the volume, time of day, and location that electricity will be needed.

But, as recent events have demonstrated, atypical and extreme weather patterns make predictions more difficult, affects resiliency and reliability of grid dependent needs, and creates vulnerabilities for end users.

In addition, there is a serious lack of charging stations. For example, while drivers are accustomed to filling their gas tank in less than five minutes, a Tesla model 3 can be charged up to 83% in 31 minutes, providing 196 miles in driving range. The problem is that on some interstate routes and rural areas, there are no charging stations within 196 miles.

In addition, there is a complexity of EV charging networks. EV makers like Ford and GM have cobbled together charging networks. In Ford's case across seven systems (GM uses nine), in order to support the 21K customers, who have bought their Mustang Mach E., with the average cost for Level 3 fast chargers in the low six-figures, they have forged more economical solutions involving roaming agreements, etc., in order to provide EV owners with maps of charging station for their Blue Oval Charge Network. It is more complicated than it seems because of different layers of relationships between:
Between the charger and the vehicle, which lack standards,
The driver and network in securing payment, and
The roaming network, the latest complexity.

While Tesla owners benefit from the fact that Tesla owns and designs the cars, plugs, charging networks, and software, they do not have models that include e-Vans, and e-Trucks.

As of 2020, there were only 4,300 locations with the fastest Level 3 DCFC (Direct-Current Fast Charger) chargers available to the public, and the current amount of EVs on the road cannot financially justify the additional infrastructure. The average cost for a Tesla Level 3 Station with 6-8 stalls is $250K.

Furthermore, there is an interest in increased revenue by retailers and brand perception by consumers for EV charging stations. For example, despite the cost of EV infrastructure, retailers continue to add them due to the increase in revenue, perception of brand eco-consciousness, and preferential shopping created by EV charging convenience. Target found that EV drivers spent more than 3× longer in the store, an increase in “dwell” time from 22 to 72 minutes. They estimated an increase in gross revenue of $56K while the cost of electricity was $430 for Level 2 chargers. While charging times for Level 3 chargers are shorter, they experience more continuous heavy usage compared Level 2 chargers according to a DOE commissioned study. A Volvo 2019 study showed that a quick charging option was the most desirable feature at charging locations. Another study listed grocery stores as the most convenient EV charging locations by potential EV customers. Other locations include restaurants, shopping malls, recreation areas, and etc.

Therefore, it is desired to provide various EV charging solutions that are capable of providing portable, sustainable, propane-powered, charging solutions for EVs while minimizing carbon emissions as much as possible.

### SUMMARY OF THE INVENTION

An object of the present invention is to provide various EV charging solutions that are capable of providing portable, sustainable, propane-powered, charging solutions for EVs while minimizing carbon emissions as much as possible.

In order to achieve the above object, according to an aspect of the present invention, there is provided a charging system for a mobile and portable high-capacity Electrical Vehicle (EV) charging station, where the charging system comprises a plurality of propane tanks for generating power, a generator, an EV charger, a voltage selector switch, a plurality of solar panels for charging onboard batteries due to parasitic loads, a communication backhaul, a security device, a diagnostics and monitoring device for monitoring the plurality of tanks, the generator, and the EV charger.

Here, the charging system is configured to be used in a plurality of platforms, the plurality of platforms comprising: a skid; a truck; a trailer; and a pod.

Further, the charging system further comprises a software architecture capable of detecting where the charging system is at all times, diagnosing the charging system remotely, and processing advanced data analytics to improve performance.

Further, in the charging system, the software architecture is built with the ability to augment computer vision using machine learning and AI (Artificial Intelligence).

Further, the charging system further comprises an onboard data system through a NERD (Networked Electronic Resources Distribution) Box, which combines all of the necessary onboard electronics, advanced sensors, communication gateway, redundant data portals with cloud connectivity that is kept powered 24/7 through renewal solar energy and energy storage system.

Here, the onboard electronics connect all of the major systems within the charging system and ensures reliable communication between the plurality of propane tanks, the generator, the EV charger, the plurality of solar panels, the security device, and the diagnostics and monitoring device.

Further, in the charging system, the advanced sensors comprise an ultrasonic propane tank level sensor that is noncontact, non-intrusive, accurately and reliably manages, monitors the level of propane fuel on board and is integrated with cloud connectivity, to automatically alert the nearest propane provider to ensure reliable delivery and refill the plurality of propane tanks.

Here, in the charging system, wherein even when a generator power is off, a user interface screen of the EV charger is active through an onboard parasitic power source and an electronic circuitry design.

Further, in the charging system, the NERD Box networks onboard camera system and safety lighting systems for security protection.

Further, in the charging system, all data is securely uploaded in a cloud server.

Further, the charging system is configured to use either rLPG (renewable Liquid Petroleum Gas) or rDME (renewable Dimethyl Ether) for energy source.

Further, the charging system is further extended to a multiple-way charging station, in which a plurality of EVs are charged simultaneously.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates several platforms of propane fueled mobile and portable high-capacity EV charging stations of the present invention—skid integrated, truck mounted, trailing integrated, and in a pod;

FIG. 2 illustrates an overview of the propane fueled mobile and portable high-capacity EV charging stations of the present invention;

FIG. 3 shows a table, in which components of the propane fueled mobile and portable high-capacity EV charging stations shown in FIG. 2 are summarized;

FIG. 4 shows a graph showing that carbon intensity levels for propane LPG, rLPG, and rLPG and rDME are significantly lower than diesel and gasoline;

FIGS. 5(a)-(g) show several views illustrating the mobile and portable high-capacity EV charging stations with a truck platform;

FIG. 6 shows an overview of the mobile and portable high-capacity EV charging stations with a skid platform;

FIG. 7 shows an exploded view illustrating the mobile and portable high-capacity EV charging stations with a skid platform;

FIG. 8(a)-(c) show several views illustrating the mobile and portable high-capacity EV charging stations with a skid platform—FIG. 8(a) shows a top view, FIG. 8(b) shows a side view, and FIG. 8(c) shows a front view;

FIG. 9 shows a beacon light distance communication system of the propane fueled mobile and portable high-capacity EV charging stations of the present invention;

FIG. 10 shows an overview of the mobile and portable high-capacity EV charging stations with a trailer platform;

FIG. 11 shows an inside view of the mobile and portable high-capacity EV charging stations shown in FIG. 10;

FIG. 12(a)-(f) show several views illustrating the mobile and portable high-capacity EV charging stations in FIG. 10-FIG. 12(a) shows a top view, FIG. 12(b) shows a rear view, FIG. 12(c) shows a passenger side view, FIG. 12(d) shows a bottom view, FIG. 12(e) shows a front view, d FIG. 12(1) shows a driver side view;

FIG. 13 shows an overview of another example of the mobile and portable high-capacity EV charging stations with a trailer platform;

FIG. 14 shows an inside view of the mobile and portable high-capacity EV charging stations shown in FIG. 13;

FIG. 15(a)-(f) show several views illustrating the mobile and portable high-capacity EV charging stations in FIG. 14—FIG. 15(a) shows a top view, FIG. 15(b) shows a rear view, FIG. 15(c) shows a passenger side view, FIG. 15(d) shows a bottom view, FIG. 15(e) shows a front view, and FIG. 15(f) shows a driver side view;

FIG. 16 illustrates a six-way charging station of the propane fueled mobile and portable high-capacity EV charging stations of the present invention;

FIG. 17 illustrates a situation where six EVs are charged simultaneously in a six-way charging station shown in FIG. 16;

FIG. 18 illustrates a control panel box of a six-way charging station shown in FIG. 16;

FIG. 19 shows a charger of a six-way charging station shown in FIG. 16;

FIG. 20 shows charging indicators in LED for a six-way charging station shown in FIG. 16;

FIG. 21 shows a status of the charging process in stop button equipped with an LED ring for a six-way charging station shown in FIG. 16;

FIG. 22 shows a solar control panel display for a six-way charging station shown in FIG. 16;

FIG. 23 shows the NERD (Networked Electronic Resource Distribution) Box of the mobile and portable high-capacity EV charging stations of the present invention;

FIG. 24 shows a schematic circuit for a tank level meter voltage to current convertor board;

FIG. 25 illustrates a 3D view of the board shown in FIG. 24;

FIG. 26 illustrates parts placements of the board shown in FIG. 24; and

FIG. 27 shows examples of how an onboard safety helmet and safety glass set (“e-Boost AR”) is used.

### DETAILED DESCRIPTION OF THE INVENTION

Hereinafter, the present invention will be described in detail with reference to the accompanying drawings. In denoting reference numerals to constitutional elements of respective drawings, it should be noted that the same elements will be denoted by the same reference numerals although they are illustrated in different drawings. In the embodiments of the present invention, the publicly known functions and configurations that are judged to be able to make the purport of the present invention unnecessarily obscure will not be described.

Propane fueled mobile and portable high-capacity EV charging stations of the present invention are designed with the following five design principles at their foundation:
Mobile EV charging: EV charging wherever & whenever—Department of Transportation (DOT) compliant design;
Power ON: always available on-demand sustainable power production and back-up power;
Data connectivity: secure, frictionless data connection for remote monitoring, advanced analytics, and predictive maintenance to ensure uptime;
Grid resilience: off-grid, but always ON; and
Sustainability: liquefied petroleum gas (LPG) for green fuel today, renewable LPG (rLPG) for tomorrow, rLPG and renewable dimethyl ether (rDME) next-path to net zero carbon intensity without any hardware or design changes.

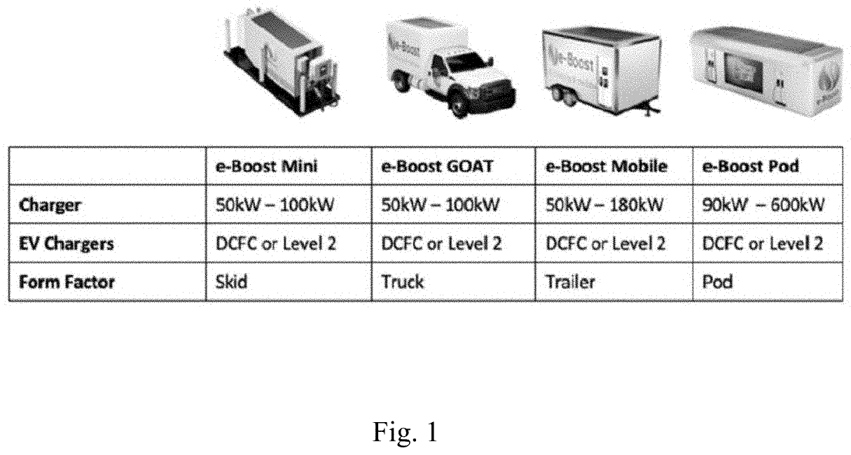

The present invention describes several different platforms, where these design principles are seamless integrated—for example, skid integrated, truck mounted, trailing integrated, and in a pod, as shown in FIG. 1. FIG. 1 also shows charger and EV chargers for each platform.

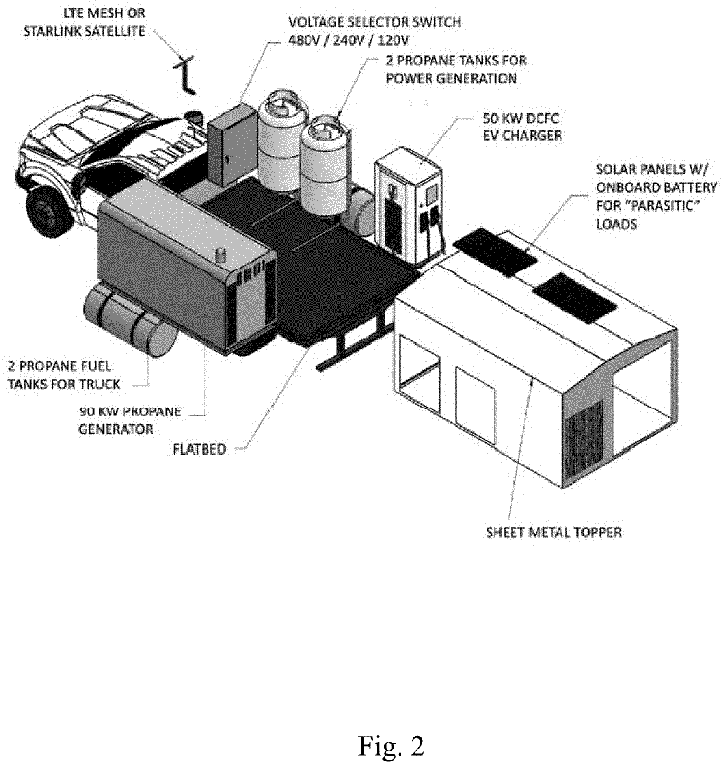

FIG. 2 shows an overview of the propane fueled mobile and portable high-capacity EV charging stations of the present invention. It is noted that regardless of the configuration shown in FIG. 1, the propane fueled mobile and portable high-capacity EV charging stations have multiple options for providing mobility, power, resilience, sustainability, and connectivity.

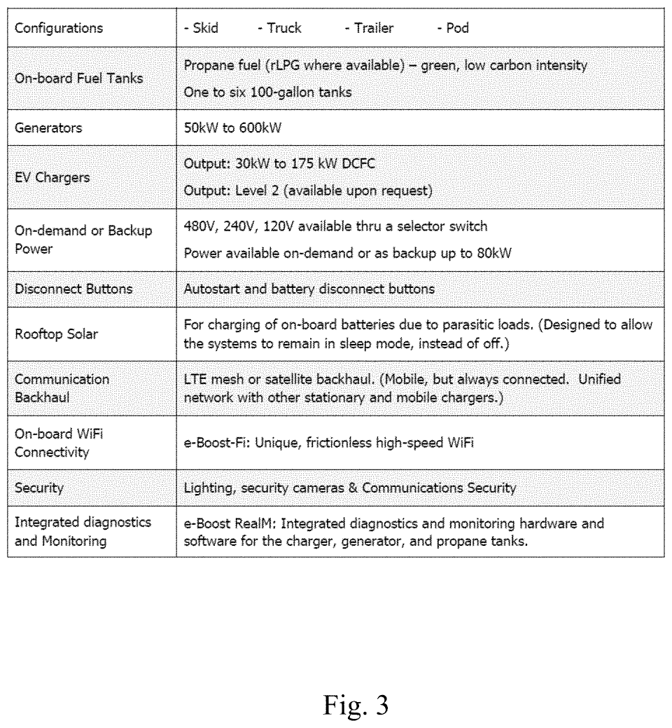

FIG. 3 shows a table, in which components of the propane fueled mobile and portable high-capacity EV charging stations shown in FIG. 2 are summarized. The first column includes several components of the propane fueled mobile and portable high-capacity EV charging stations—onboard fuel tanks, generators, EV chargers, on-demand or backup power, disconnect buttons, rooftop solar, communication backhaul, onboard Wi-Fi connectivity, security, and integrated diagnostics and monitoring. The second column includes information for each component of the propane fueled mobile and portable high-capacity EV charging stations.

The above design principles will be described more in detail below with references to the accompanying drawings.

### Mobility

Mobility is the base principle of design and defines the uniqueness of the present invention. Truck mounted EV Charging (“e-Boost GOAT”) is always mobile, Trailer mounted EV Charging (“e-Boost Mobile”) is mobile, as needed and the Skid integrated (“e-Boost mini”) and Pod integrated (“e-Boost Pod”) are mobile, as required. The mobile and portable high-capacity EV charging stations are designed and tested around DOT compliance to ensure that the performance is assured while moving from place to place, and the permitting process is also DOT compliant to ensure that EV charging is provided anywhere.

### Power

Power production is an integral part of the mobile and portable high-capacity EV charging stations. Through this ability to produce power on demand, anywhere, at any time, performance and availability are assured. In addition, the mobile and portable high-capacity EV charging stations choose a green fuel source platform, propane, for which America is the world's largest producer and exporter, with an extensive distribution network, especially in small towns and rural areas, with propane providers that deliver propane to specific sites whenever requested. Propane is easily transportable, readily available and is cleaner and costs less than diesel. This makes the power production of the mobile and portable high-capacity EV charging stations reliable, resilient, and cost effective.

Furthermore, the mobile and portable high-capacity EV charging stations is generator brand agnostic but integrate all of the generator controller intelligence into a cloud dashboard. This allows for continuous monitoring and timely and predictive maintenance of the power asset ensuring uptime. The remote control and monitoring also allows the remote start and stop of the power asset in cases of emergency and provides power to the onboard energy storage unit that ensures data connectivity and communication are maintained at all tithes,

### Data Connectivity

Data connectivity aboard the mobile and portable high-capacity EV charging stations is the central nervous system that makes it intelligent and reliable today, while making it future-proof to be automated, and adaptable to newer, upcoming technologies and can be integrated to any outside systems through API (Application Programming Interface). The ability to be able to know where the mobile and portable high-capacity EV charging stations are at all times, how they are performing and being able to remotely diagnose them, process advanced data analytics to continually improve performance require a sophisticated software architecture that makes charging anywhere and everywhere possible.

Additionally, the base architecture is built with the ability to augment computer vision using machine learning and AI (Artificial intelligence) to continually improve the mobile and portable high-capacity EV charging stations.

The onboard data system is networked through the NERD (Networked Electronic Resource Distribution) Box, which combines all of the necessary onboard electronics, advanced sensors, communication gateway, redundant data portals with cloud connectivity that is kept powered 24/7 through renewal solar energy and energy storage system. The onboard electronics connect all of the major systems within the mobile and portable high-capacity EV charging stations and ensures reliable communication between propane fuel system, propane generator, the EV chargers, the rooftop solar system, the battery energy storage for parasitic loads and camera and safety light systems.

The advanced sensors onboard include an ultrasonic propane tank level sensor that is noncontact, non-intrusive, yet accurately and reliably manages, monitors the level of propane fuel on board and is integrated with cloud connectivity, to automatically alert the nearest propane provider to ensure reliable delivery and refill of the onboard propane tanks, as required.

The NERD Box has at least two sources of data connectivity onboard at all times: dual/tri band cellular connectivity for most places with an automatic fail over sequence for satellite backhaul of data utilizing services like Starlink or Viasat or hiSky. This ensures that the mobile and portable high-capacity EV charging stations are always online and able to connect and communicate even during disaster situations.

A unique feature of the mobile and portable high-capacity EV charging stations is that even when the generator power is off, the user interface screen of the onboard EV Charger is kept ‘alive’ (active) through the onboard parasitic power source and through an innovative electronic circuitry design, which ensures that the EV charger can be communicated with, initiated and charging under one minute and not experience long latency period for powering up. This is the feature specifically unique only to chargers integrated in the mobile and portable high-capacity EV charging stations.

The NERD Box also networks the onboard camera systems and safety lighting systems which not only provides security for the EV charging personnel, but also protects against vandalism and crime. The ingesting of this video feed data is also being utilized to enhance the charging experience by applying computer vision and with ML and AI which learns to detect charging issues from the facial and other human actions of EV charging personnel, thereby allowing for proactive onboard diagnostics to be run and remotely fix issues to provide increased uptime.

All of this data is securely uploaded to a cloud server, and the online monitoring (“e-Boost RealM”) is passcode protected and accessible to assigned users and monitored 24/7 by live human service personnel, who can escalate and engage appropriate personnel, if there are any system issues. The online monitoring automatically contacts propane providers for refueling via email or text messages, can initiate remote start of power generator in emergency situations and also repower onboard energy storage systems, if they run low in inclement weather situations.

Each of the mobile and portable high-capacity EV charging stations is delivered with an onboard safety helmet and safety glass set (“e-Boost-AR”) that is integrated with augmented reality technology to be worn by any qualified local technician with minimal training that will automatically connect to master technicians providing them with ‘remote eyes & ears’ and accurate guidance of any required equipment repairs. This type of technology saves time and cost and ensures maximum uptime of equipment for the mobile and portable high-capacity EV charging stations.

Therefore, the data connectivity of the mobile and portable high-capacity EV charging stations makes it far more advanced and specifically different from any other EV charger n the market as it is continually learning ways to improve the EV charging experience and assuring uptime.

### Grid Resilience

Grid Resilience is becoming more and more essential as there is a higher requirement for reliable power grid, especially as more energy assets rely on it including and especially EVs. At the same time, the realities of climate change are creating unusual and unpredictable weather patterns around the globe, which creates more power outages and even greater stress on grid operators. For this specific reason, the mobile and portable high-capacity EV charging stations is able to be off grid and operate with autonomy with networked fuel providers wherever it is needed. This makes the mobile and portable high-capacity EV charging stations a perfect disaster recovery tool for any type of adverse weather situation or in high stress grid situations to ensure that EV vehicles are not left stranded, emergency power is available, and necessary communication is available to survive any lapses in grid availability.

### Sustainability

Sustainability was at the heart of the fuel selection for the mobile and portable high-capacity EV charging stations. Aside from being readily available, easily transportable, and cost effective, propane produces 43 percent fewer greenhouse gas emissions than grid-generated electricity, based on national averages. It is a clean burning alternative to gasoline and diesel that complements long-term renewable technologies. Also, methane-free, propane produces extremely low levels of nitrogen oxides and has virtually no particulate matter. The 1990 amendment of the Clean Air Act introduced a nationwide approach to reduce acid pollution. Propane is an approved clean fuel listed in the 1990 Clean Air Act and is free of Sulfur, thus dramatically reducing emissions of sulfur dioxide (SO2) and oxides of nitrogen (NOx). Propane is listed as an approved alternative fuel as described in the Federal Highways Administration's (FHWA) Alternative Fuel Corridors (AFC). Propane also offers a pathway to net-zero emissions with the commercial-scale production of renewable liquid petroleum gas (rLPG), which began in early 2022, lowering its carbon intensity to 19%. Renewable dimethyl ether (rDME) is a fuel additive that further reduces propane's carbon intensity to 0%. rDME started production in late 2022. Both rLPG and rDME are derived from bio-feedstock that helps to reduce landfill waste, lowers your carbon footprint, and mitigates the negative impact of transportation emissions on the environment. Moreover, the use of rLPG and rDME requires no changes to hardware for the mobile and portable high-capacity EV charging stations.

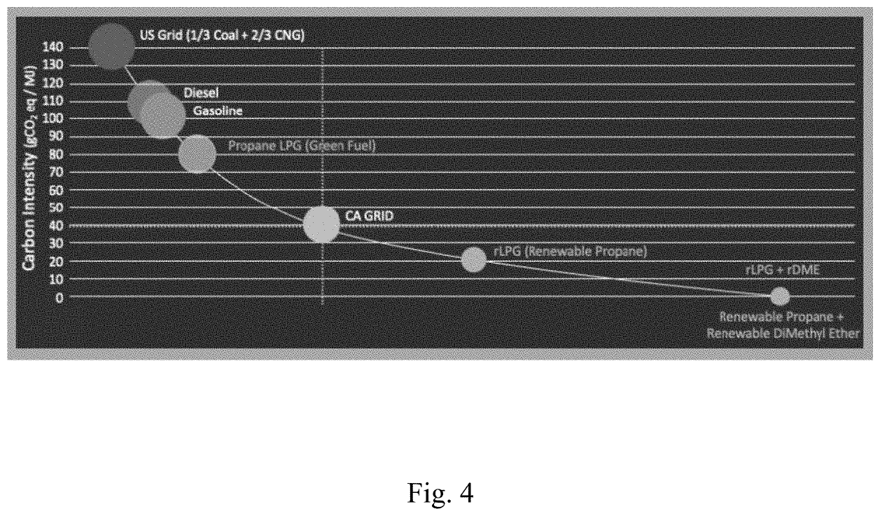

FIG. 4 shows a graph that carbon intensity levels for propane LPG, rLPG, and rLPG and rDME are significantly lower than diesel and gasoline.

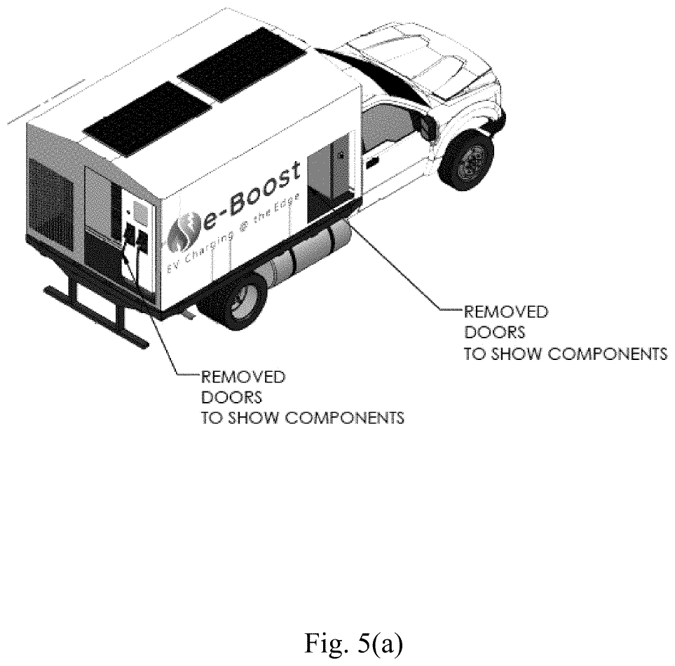

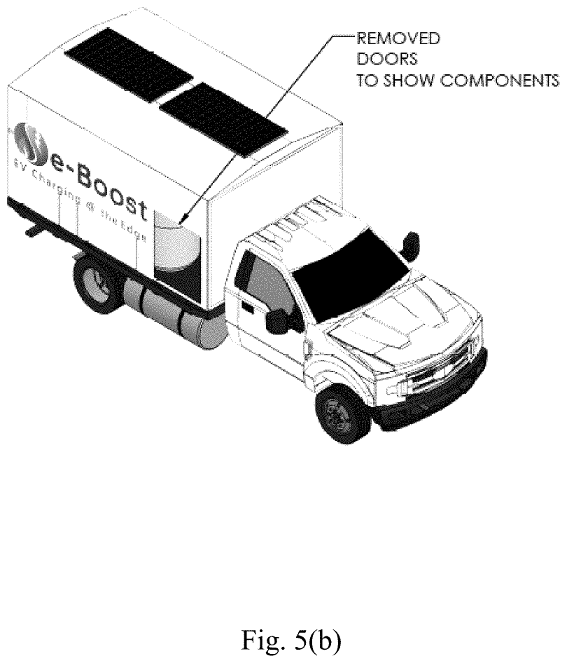

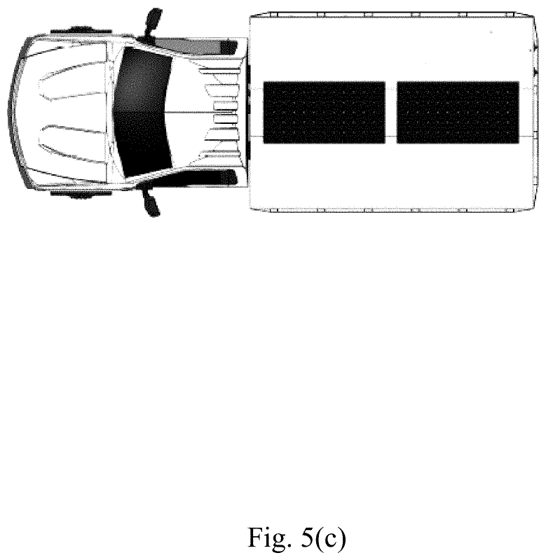

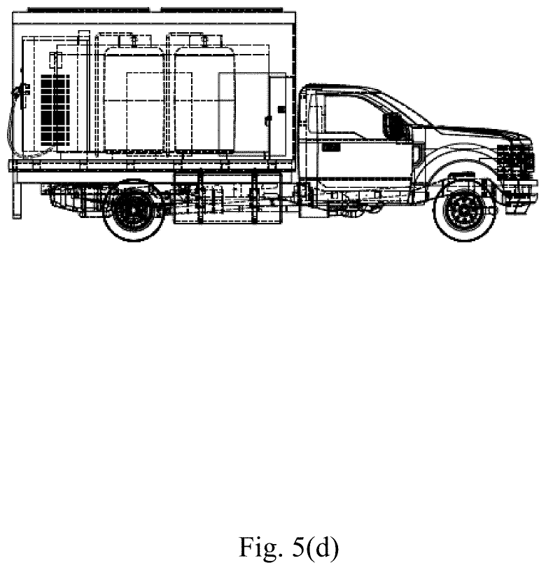

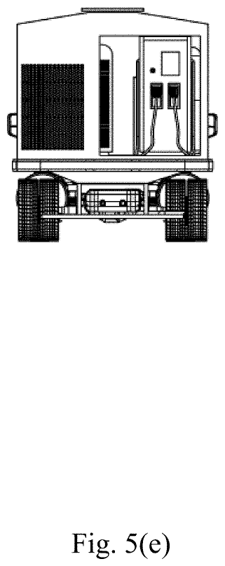

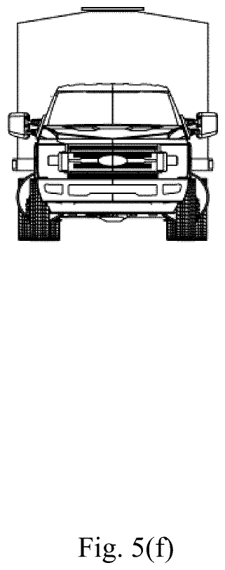

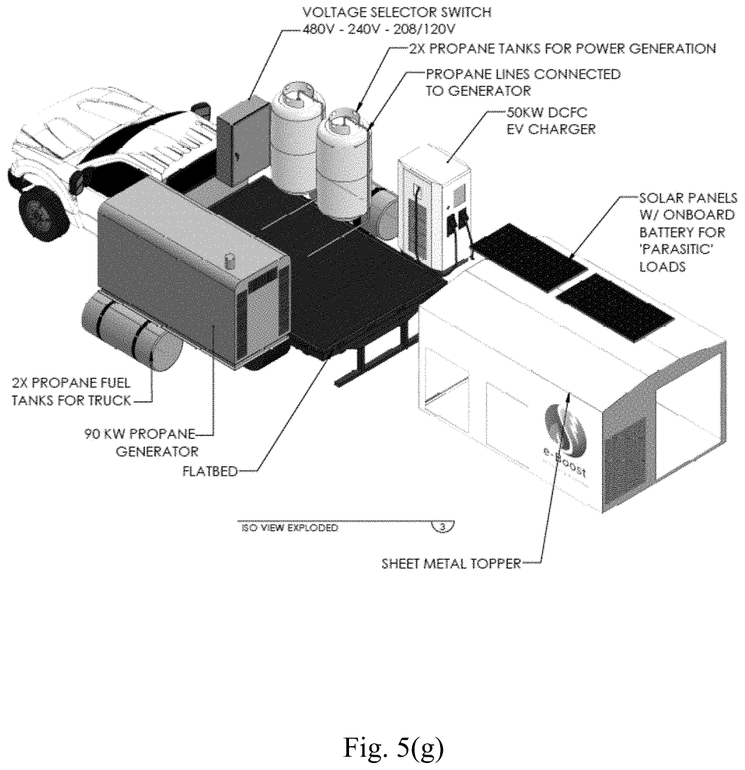

FIGS. 5(a)-(g) show several views illustrating the mobile and portable high-capacity EV charging stations with a truck platform. This platform includes two propane fuel tanks for truck, a 90 kW propane generator, a flatbed, a voltage selector switch (480V-240V-208/120V), two propane tanks for power generation, propane lines connected to generator, a 50 kW DCFC (Direct Current Fast Charging) EV charger, solar panels with onboard battery for parasitic loads, and a sheet metal topper. However, it is noted that this truck platform is not limited as shown in FIG. 5.

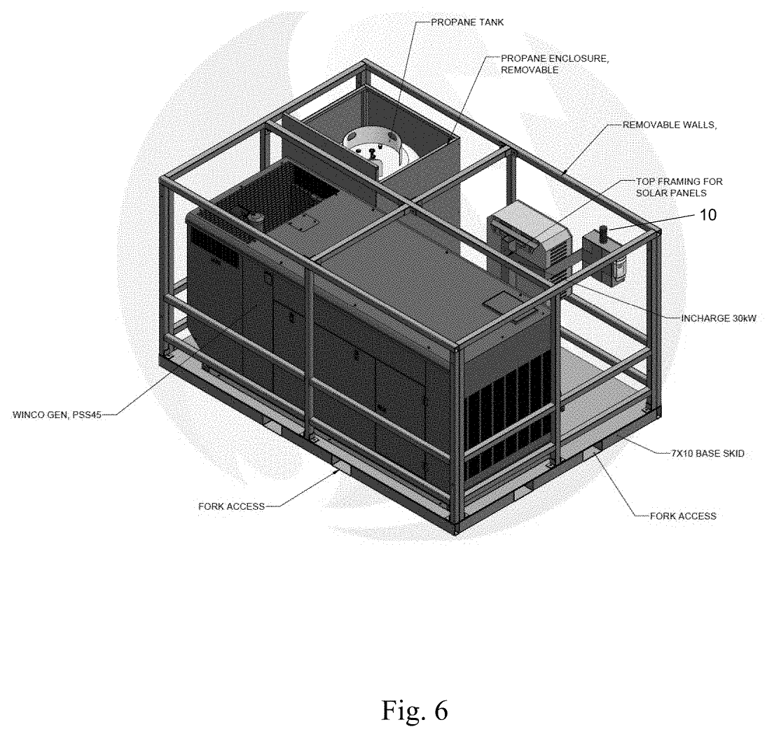

FIG. 6 shows an overview of the mobile and portable high-capacity EV charging stations with a skid platform. This platform includes a propane tank, a removable propane enclosure, removable walls, a top framing for solar panels, a charging unit, a base skid, and a generator. However, it is noted that this skid platform is not limited as shown in FIG. 6.

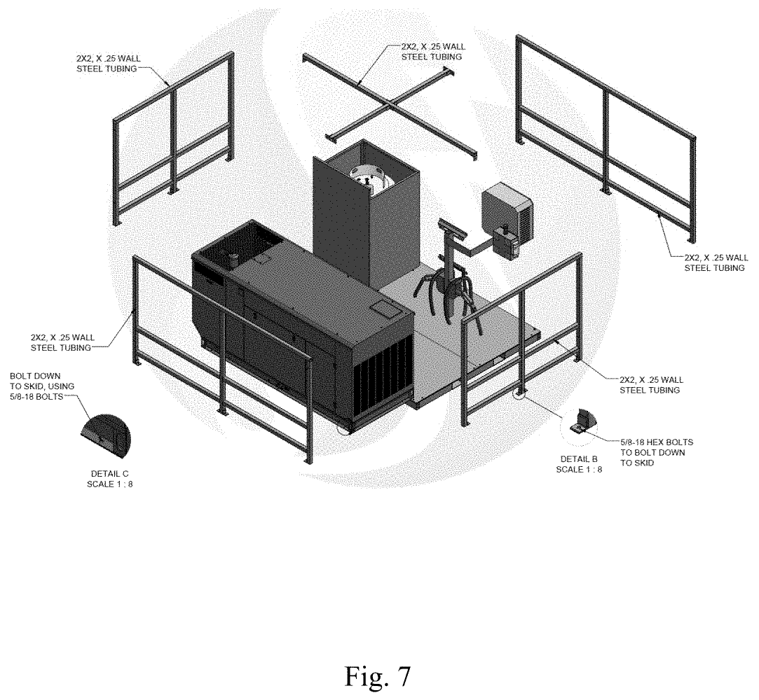

FIG. 7 shows an exploded view illustrating the mobile and portable high-capacity EV charging stations with a skid platform.

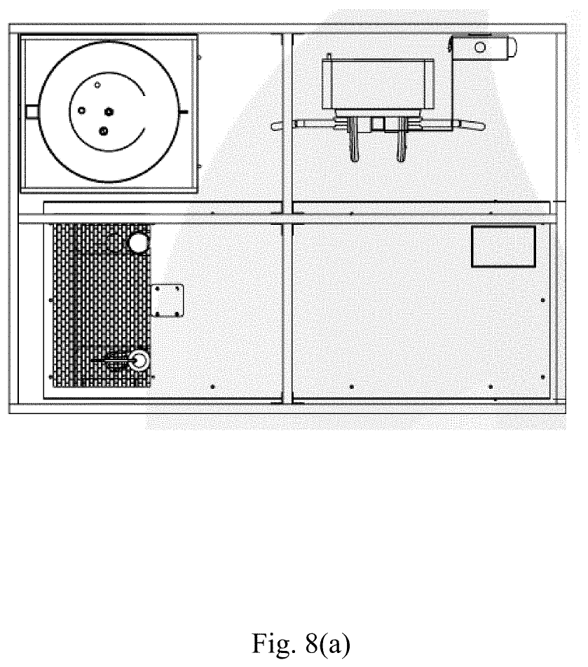

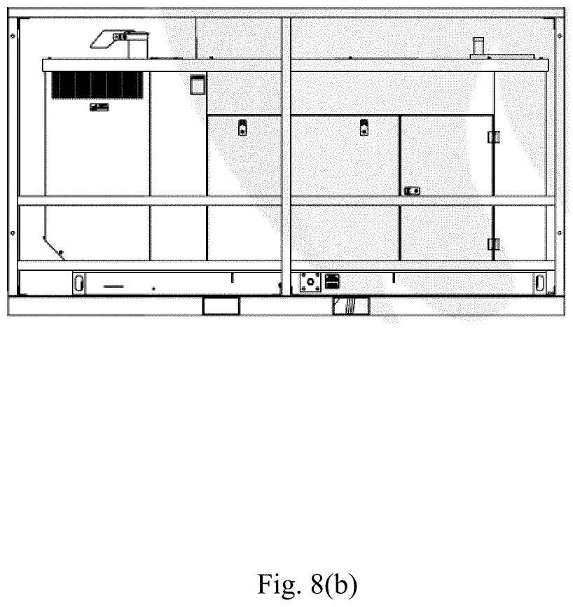

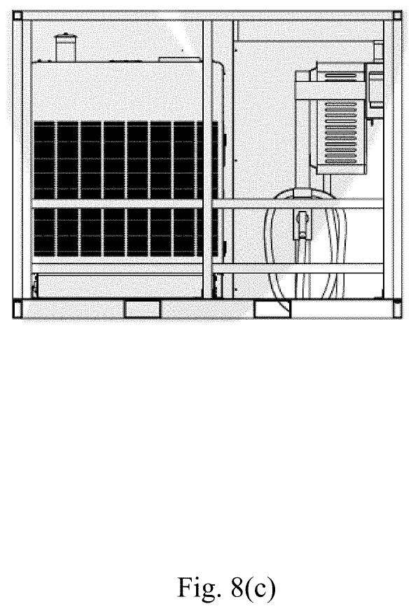

FIG. 8(a)-(c) show several views illustrating the mobile and portable high-capacity EV charging stations with a skid platform. FIG. 8(a) shows a top view. FIG. 8(b) shows a side view. FIG. 8(c) shows a front view.

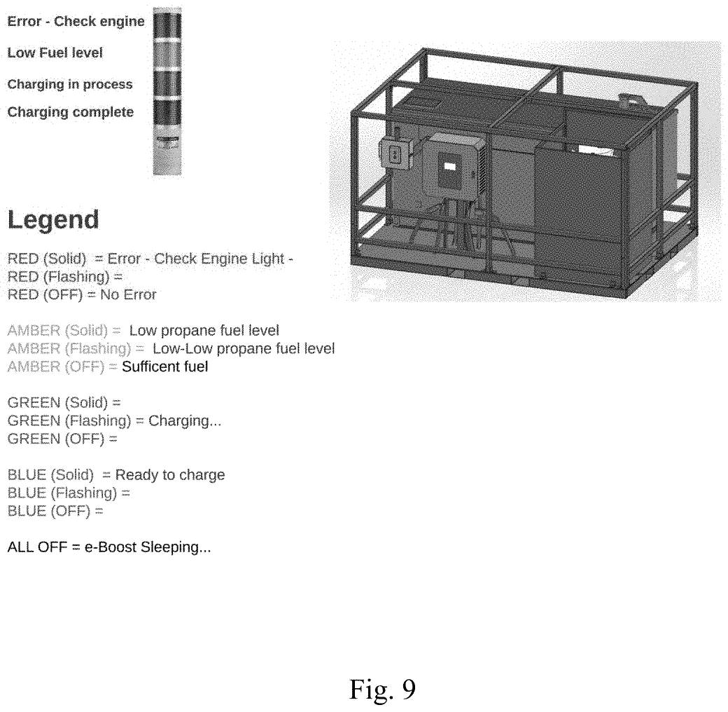

As shown in FIG. 9, this platform also includes a beacon light distance communication system, in which a beacon 10 on the charging unit is used to indicate a charging status with different colors error (check engine), low fuel level, charging in process, and charging complete. When all lights are off on the beacon, the mobile and portable high-capacity EV charging stations is in a sleeping mode.

FIG. 10 shows an overview of the mobile and portable high-capacity EV charging stations with a trailer platform. This platform includes an access door for generator, an access door for propane tanks, ventilated roofs, two doors for level two chargers, and rear barn doors.

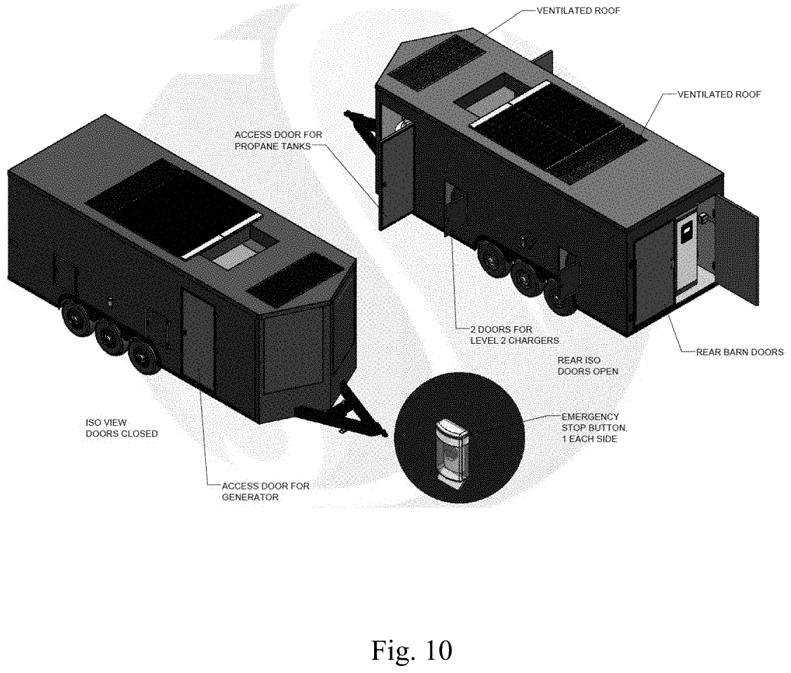

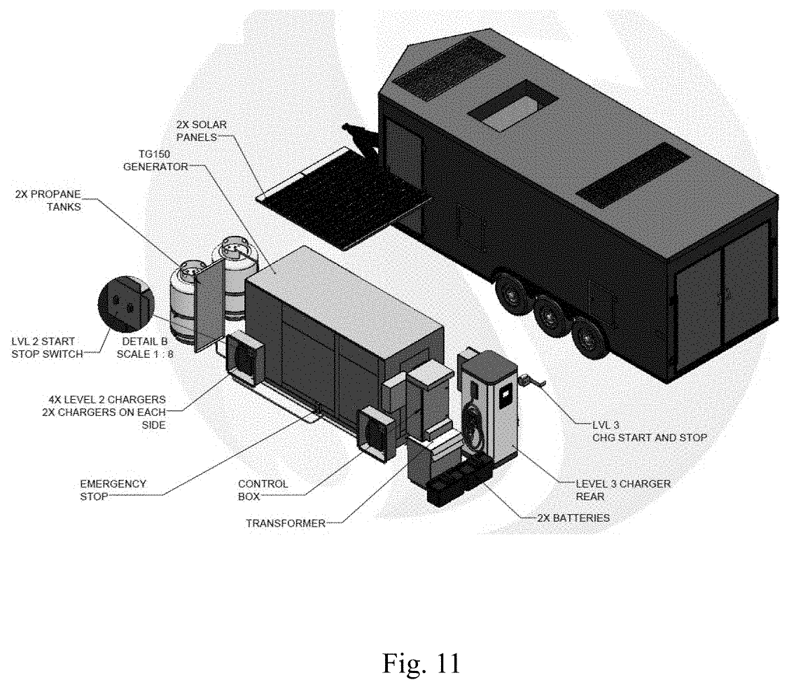

FIG. 11 shows an inside view of the mobile and portable high-capacity EV charging stations in FIG. 10, The inside view shows that the mobile and portable high-capacity EV charging stations include two solar panels, a generator, two propane tanks, a level two start stop switch, four level two chargers (two chargers on each side), an emergency stop, a control box, a transformer, two batteries, a rear level three charger, a level three charger start/stop. However, it is noted that this trailer platform is not limited as shown in FIG. 11.

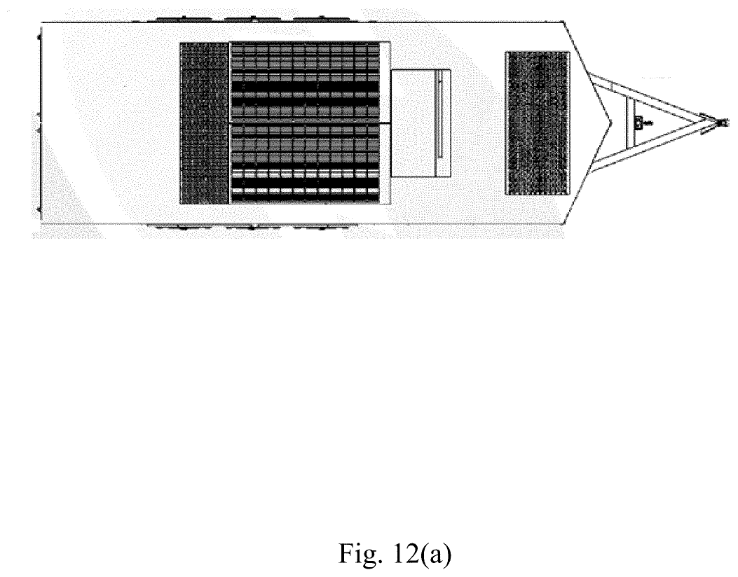

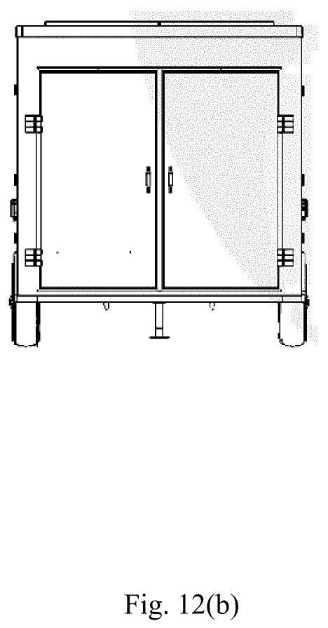

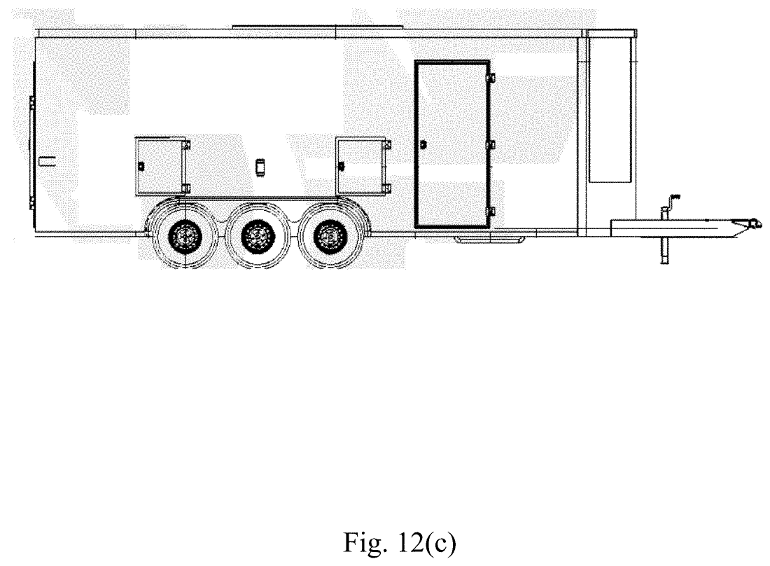

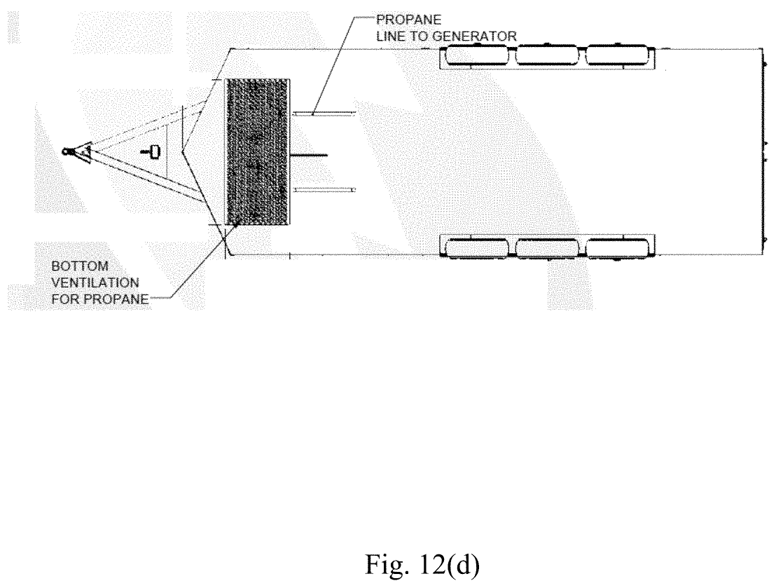

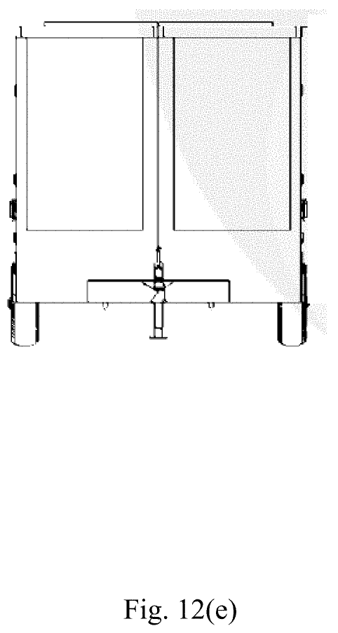

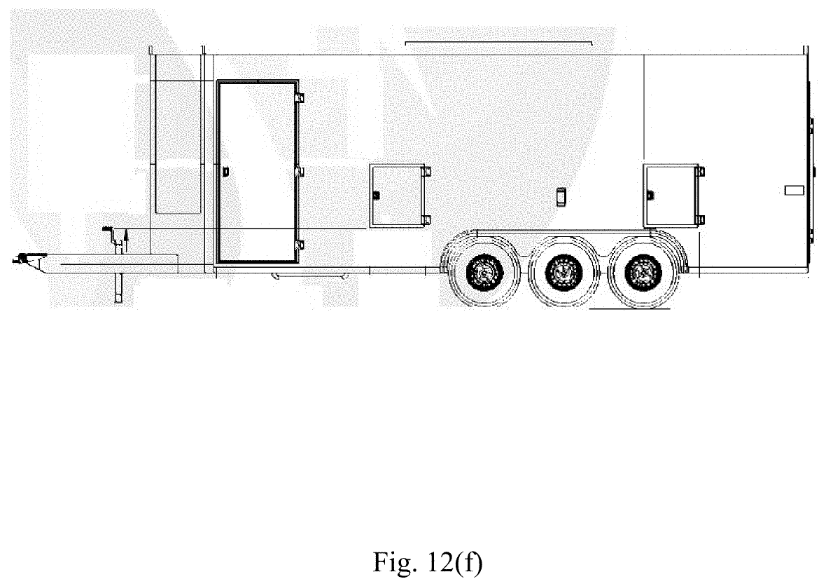

FIG. 12(a)-(f) show several views illustrating the mobile and portable high-capacity EV charging stations in FIG. 10. FIG. 12(a) shows a top view. FIG. 12(b) shows a rear view. FIG. 12(c) shows a passenger side view. FIG. 12(d) shows a bottom view. FIG. 12(e) shows a front view. FIG. 12(f) shows a driver side view,

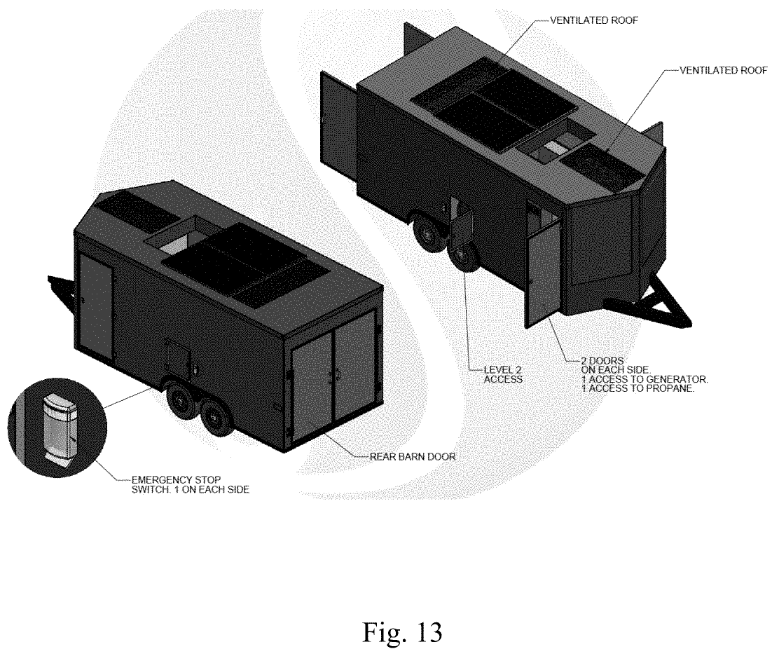

FIG. 13 shows an overview of another example of the mobile and portable high-capacity EV charging stations with a trailer platform. This example includes ventilated roofs, a level two access, two doors on each side (one access to generator and one access to propane), a rear barn door, and an emergency stop switch (one on each side).

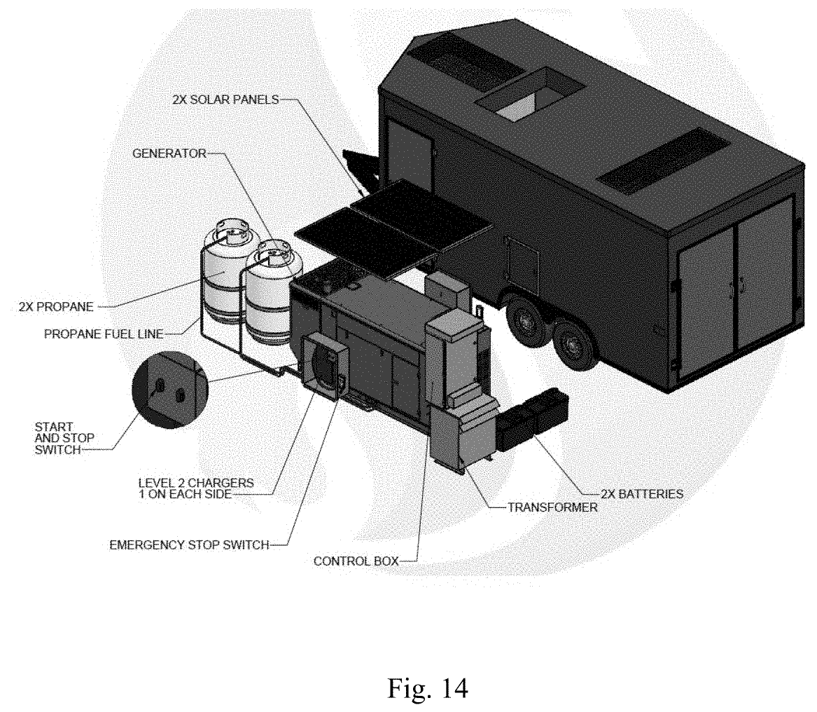

FIG. 14 shows an inside view of the mobile and portable high-capacity EV charging stations in FIG. 13. The inside view shows that the mobile and portable high-capacity EV charging stations include two solar panels, a generator, two propane, a propane fuel line, a start/stop switch, level two chargers (one on each side), an emergency stop switch, a control box, a transformer, and two batteries. However, it is noted that this trailer platform is not limited as shown in FIG. 14.

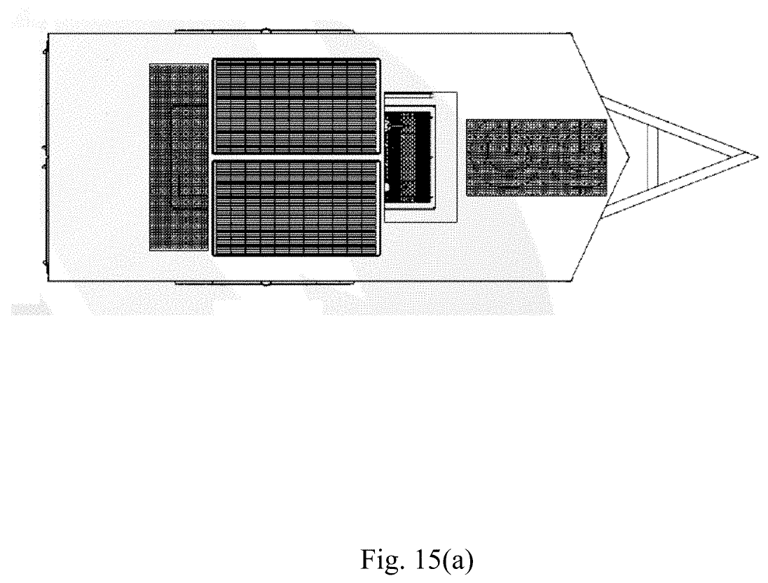

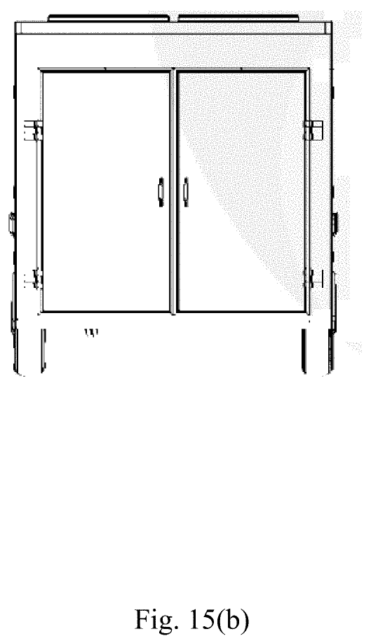

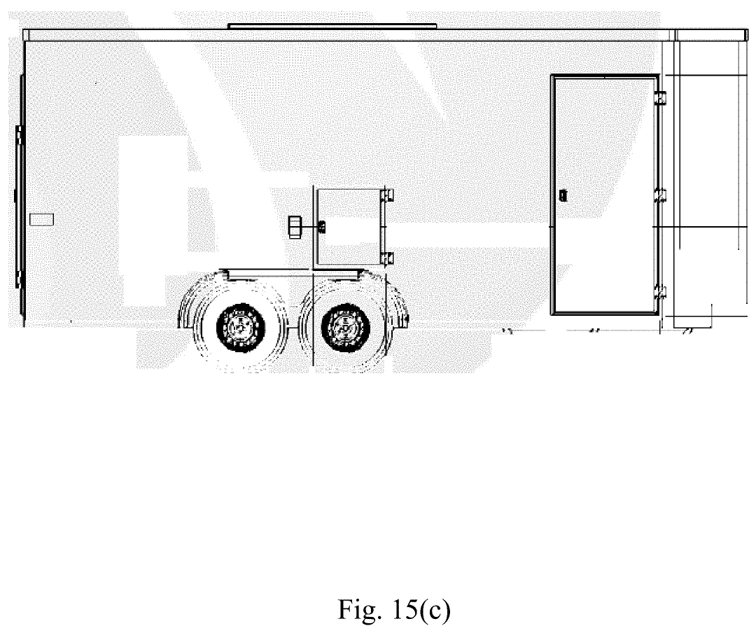

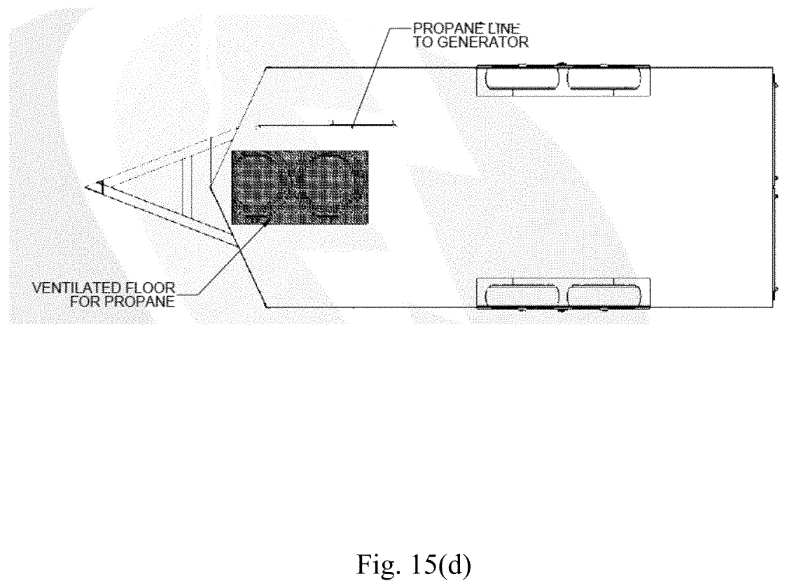

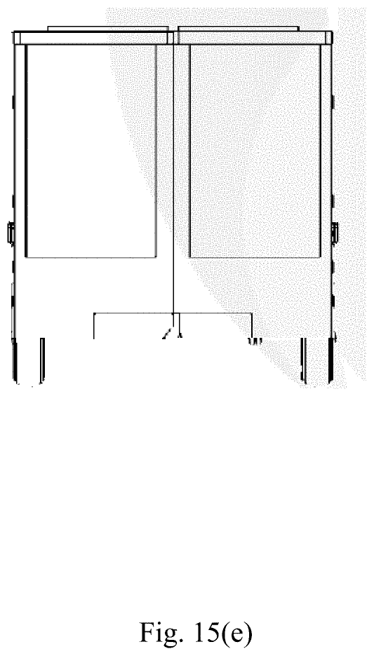

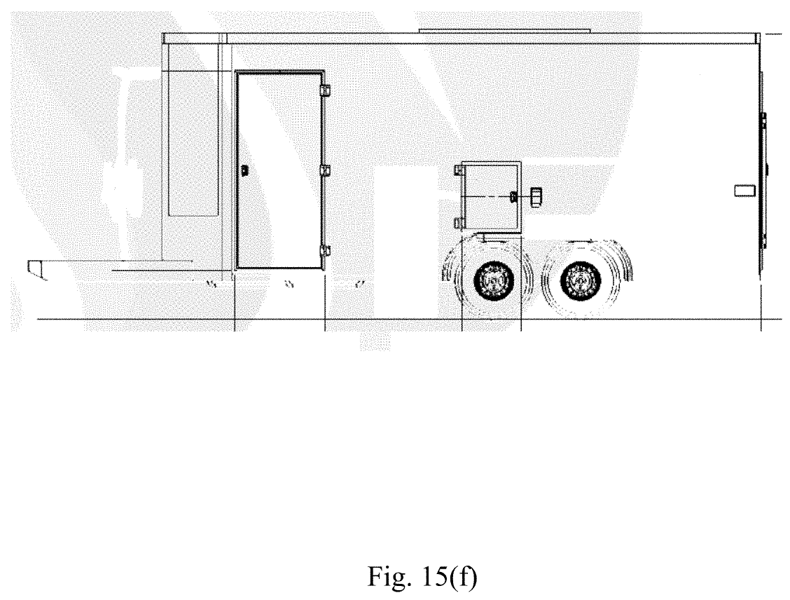

FIG. 15(a)-(f) show several views illustrating the mobile and portable high-capacity EV charging stations in FIG. 14, FIG. 15(a) shows a top view. FIG. 15(b) shows a rear view. FIG. 15(c) shows a passenger side view, FIG. 15(d) shows a bottom view. FIG. 15(e) shows a front view, FIG. 15(1) shows a driver side view.

### Six-Way Charging Station

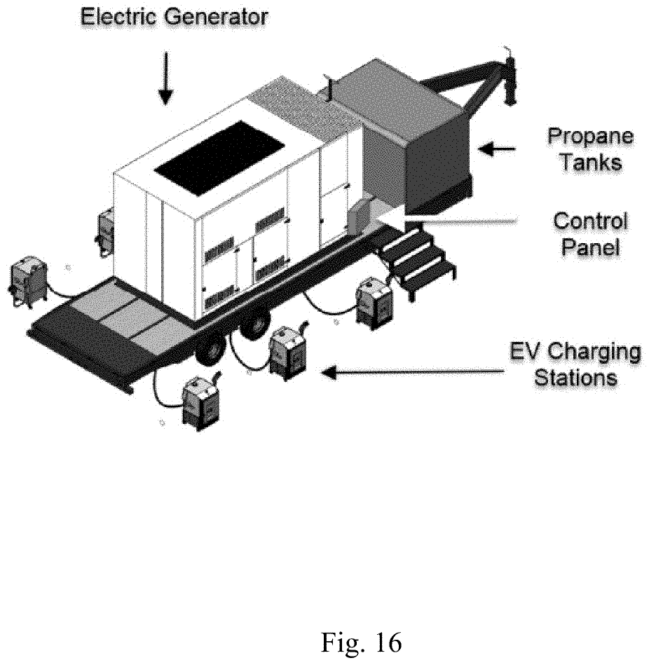

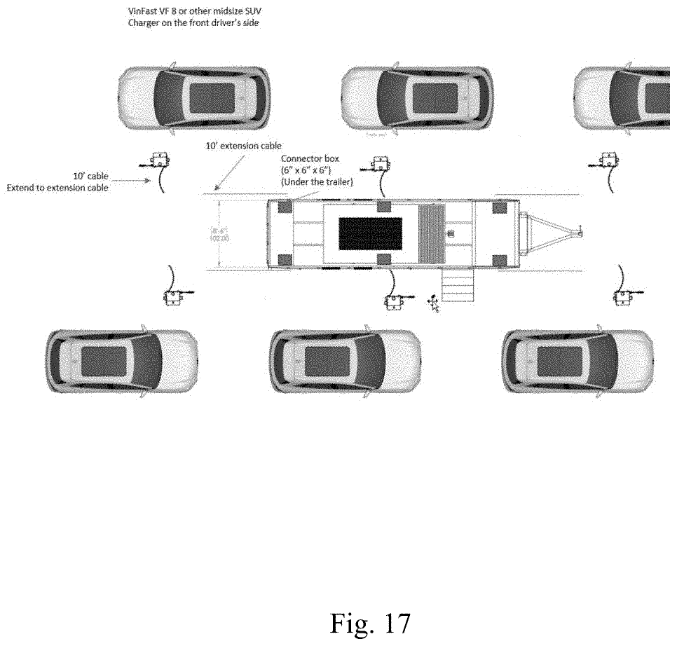

The mobile and portable high-capacity EV charging stations with a trailer platform can even be extended to a six-way charging station, as shown in FIG. 16. This is an off-grid electric vehicle charging system. In this configuration, it can charge six electric vehicles simultaneously, as shown in FIG. 17.

This six-way charging station includes the following components:
Six Heliox HE9819025-1 50 kW EV chargers; each charger has a CSS 1 connector;
400 kW electrical generator;
Six propane tanks that can provide 24 hours of uninterrupted charging, which can be monitored remotely;
A control panel that allows for starting and stopping;
Two 450 W roof mounted solar panels;
Victron Energy solar charge controller, BMS, and 2000 W inverter;
4-way LED flood lights for 360 degree lighting; and
e-Boost Realm remote maintenance software.

However, it is noted that this is just a sample design, and this six-way charging station is not limited to the above components.

This six-way charging station can be relocated using a pickup truck to any location. Once secured, the six Heliox 50 kW chargers can be plugged into the trailer using the underbed Hubbell connectors. Some chargers are intended to plug in directly, while others need an extension cable so that each charger can be positioned near the vehicle.

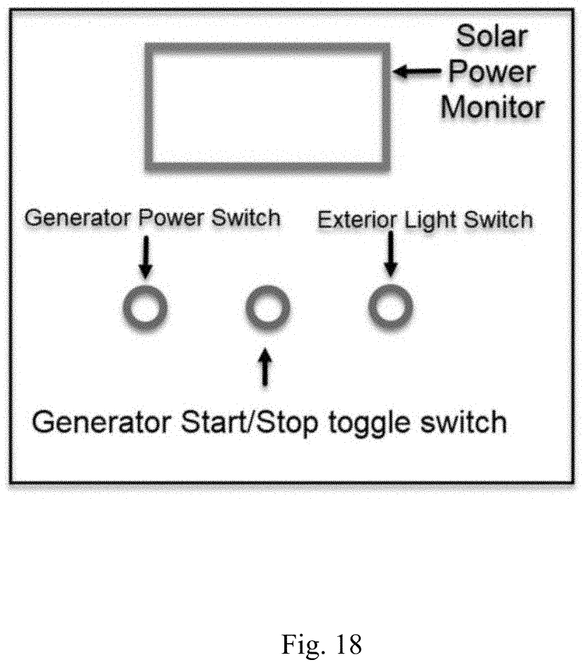

The control of this six-way charging station is centralized in a simple control panel box. This control panel box is located between the generator and the fuel tanks. As shown in FIG. 18, the panel has the following four control elements:
Solar power monitor: this touch screen displays the current state of charge of the internal batteries that power the internal electronics and flood lights; for normal operation, this panel does not need to be changed;
Generator power switch: this switch is used to power the internal electronics of the six-way charging station; during normal operations, this should always be left in the UP or ON position; if the unit is left unused for long periods, this switch should be placed in the DOWN or OFF position;
Generator start/stop toggle switch: to start or stop, the generator the start/stop toggle switch is used; this switch can be “toggled” UP to start the unit; once this occurs the switch will center itself in the middle position; to stop the unit, press DOWN on the toggle switch; once again, the switch will return to the center position; and
Exterior light switch: this switch will turn on the exterior LED lights that will illuminate the four sides of the trailer.

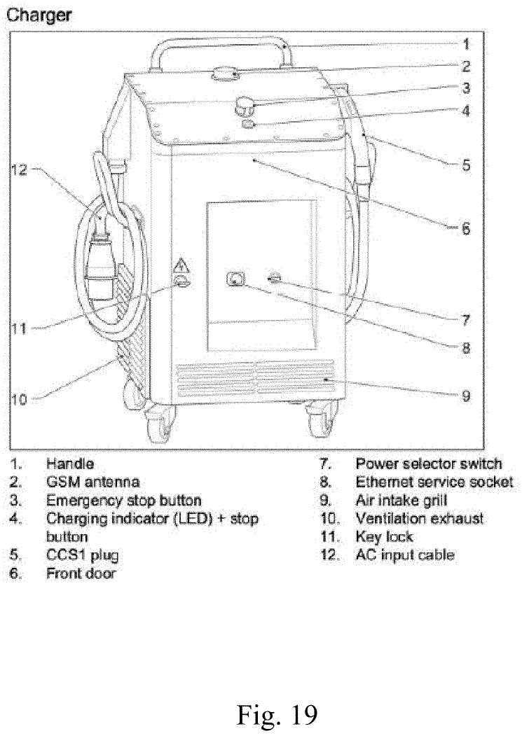

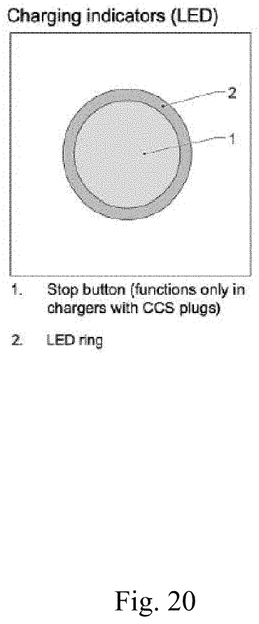

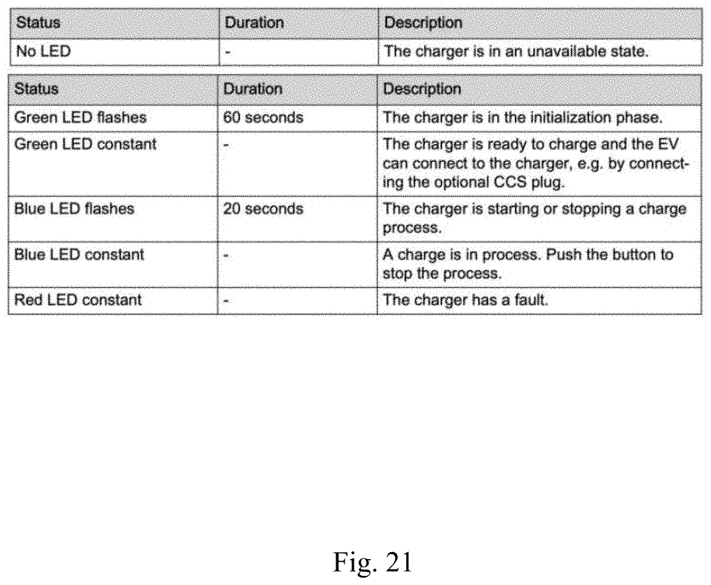

FIG. 19 shows a charger of this six-way charging station. FIG. 20 shows charging indicators in LED. The stop button is equipped with an LED ring that indicates the status of the charging process, as shown in FIG. 21.

The generator is designed to shut itself down after one hour of inactivity. Inactivity is defined as no EV charging sessions.

For example, six cars are charging and eventually five cars stop charging and leave. The one remaining car will continue to charge. But when that car's charge is completed, a one-hour timer will start. If no other cars charge in the next hour the generator will shut itself off. However, if one or more cars start charging in that hour, the timer will be reset, and charging will continue as normal.

If no EV cars are to be charged for an extended period, the system should be put into sleep mode. Since the generator is not running, this power will be drawn from our internal batteries. In a perfect world, the solar panels will keep the batteries fully charged continuously. However, storing the unit indoors or for several weeks of low sunlight will result in the generator depleting the battery. A simple way around this is to turn off the generator power switch, which is in the control panel.

For whatever reason the if the battery is depleted, a shore power connection is available to recharge the internal battery. This will allow a 110V 30 Amp Hubble cable to be connected to an internal battery charger.

To use this shore power cable:
Put the Start/Stop Generator switch in the OFF position;
Turn off the generator power switch;
Turn off the external lights switch;
Plug in the shore power cable;
Wait 30 minutes;
Turn on the Generator Power switch. If the switch turns green this indicates that sufficient power is available to start the generator. If not continue to charge the battery for another 30 minutes;
Toggle the generator start/stop switch into the start position. The generator should start. With the generator started, the internal batteries will now charge from the internal generator and the shore power cable can be disconnected; and
If the generator does not start, charge the battery for another 30 minutes and try again.

This six-way charging station has coincidently six propane tanks. These tanks are all drained simultaneously to power the generator. The refueling of the unit will be conducted by a local propane distributor. Each of the six propane tanks will need to refill separately.

On the side of the propane tanks are six values that the propane distributor will use to charge each tank. Next to the charging port is a bleed value to allow air and extra fuel to escape.

Besides charging electric vehicles, the six-way charging station provides backup power for any equipment that requires 480V 3-phase power. The connectors are located to the left when viewing the truck from the back.

The batteries keep the electronics and external flood lights powered. The battery is a 100 aH sealed lead acid battery. This battery can be charged from the following multiple sources:
Solar panels;
The 400 kW generator; and
Shore power.

For normal operations, the solar panels keep the internal battery fully charged.

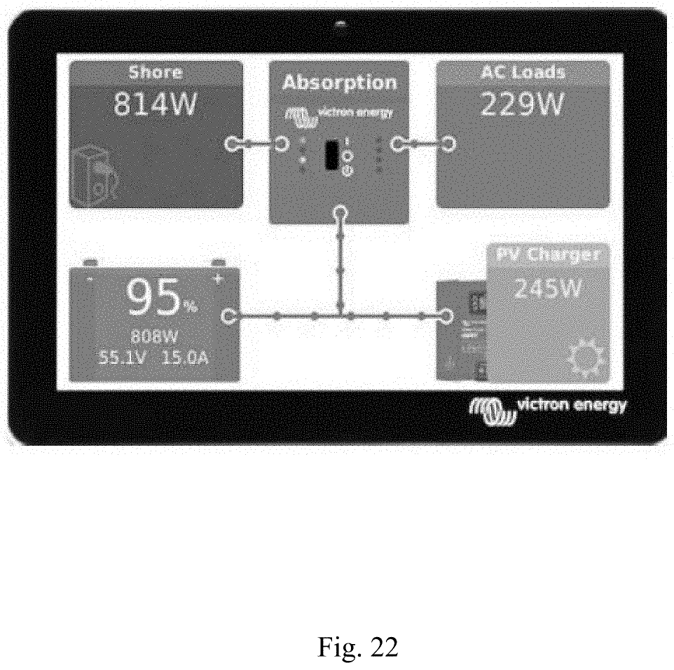

As shown in FIG. 22, the solar control panel display shows the status of the system. The battery icon in blue on the lower left shows the current charge percentage of the battery. The PV Charger icon in orange indicates the number of watts provided by the solar panels. The Shore power icon in red on the upper right shows the number of Watts being provided by the shore power connection. The AC Loads icon in green on the upper right shows the number of Watts being consumed.

### NERD Box

The onboard data system is networked through the NERD Box, which combines all of the necessary onboard electronics, advanced sensors, communication gateway, redundant data portals with cloud connectivity that is kept powered 24/7 through renewal solar energy and energy storage system.

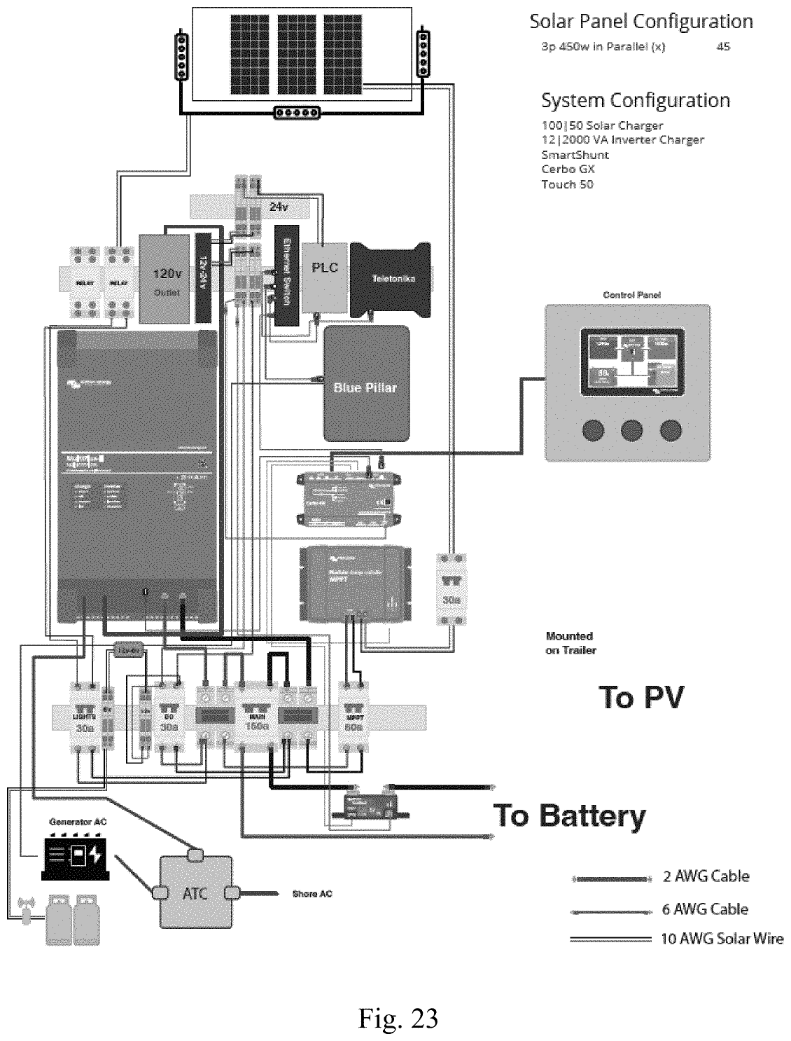

FIG. 23 shows the NERD Box of the mobile and portable high-capacity EV charging stations.

The advanced sensors onboard include an ultrasonic propane tank level sensor that is noncontact, non-intrusive, yet accurately and reliably manages, monitors the level of propane fuel on board and is integrated with cloud connectivity, to automatically alert the nearest propane provider to ensure reliable delivery and refill of the onboard propane tanks, as required.

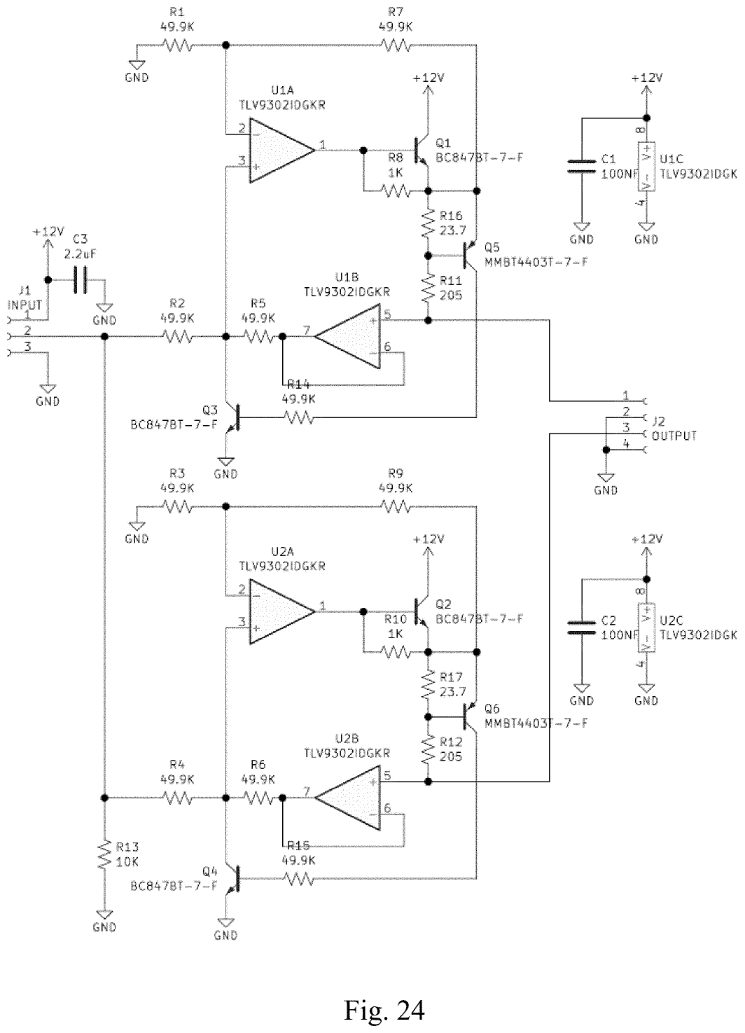

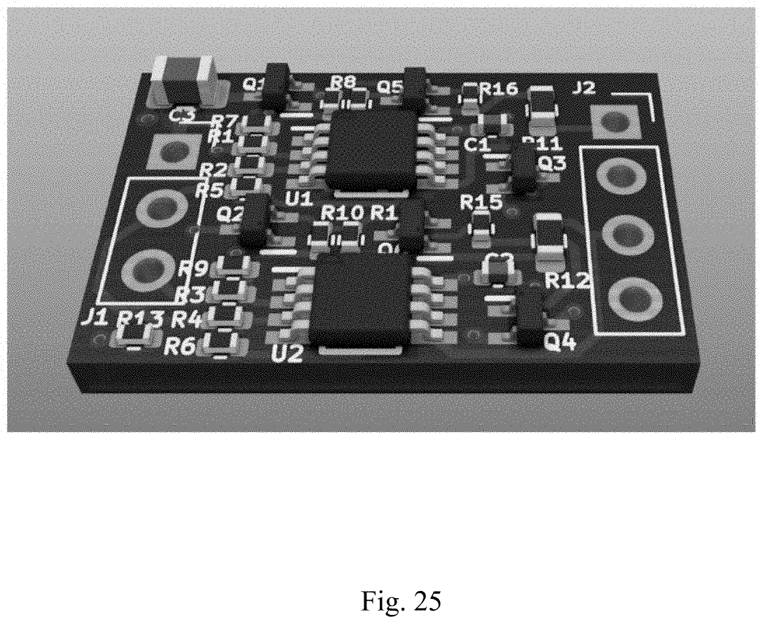

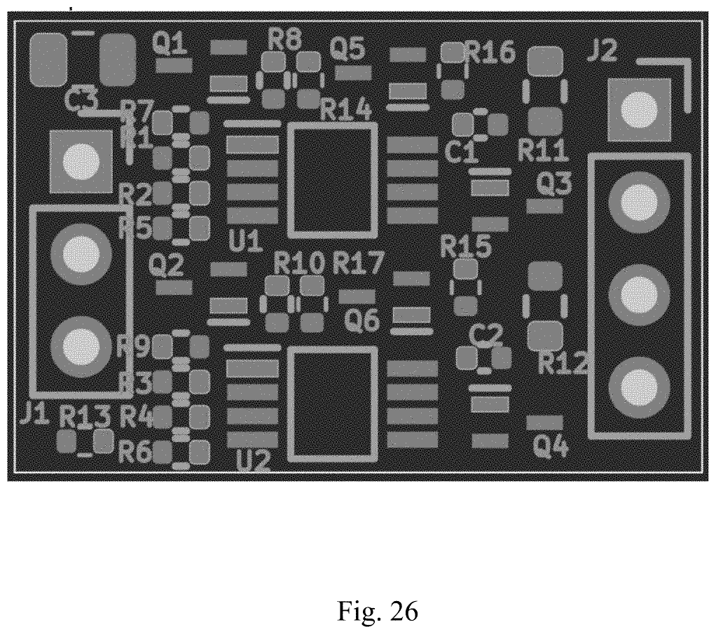

FIG. 24 shows a schematic circuit for a tank level meter voltage to current convertor board. FIGS. 25 and 26 illustrate a 3D view and parts placements of the board, respectively.

The NERD Box has at least two sources of data connectivity onboard at all times: dual/tri band cellular connectivity for most places with an automatic failure over sequence for satellite backhaul of data utilizing services like Starlink or Viasat or hiSky. This ensures that the mobile and portable high-capacity EV charging stations is always online and able to connect and communicate even during disaster situations.

A unique feature of the mobile and portable high-capacity EV charging stations is that even when the generator power is off, the user interface screen of the onboard EV Charger is kept ‘alive’ (active) through the onboard parasitic power source and through an innovative electronic circuitry design, which ensures that the EV charger can be communicated with, initiated and charging under one minute and not experience long latency period for powering up. This is feature specifically unique only to chargers integrated in the system for the mobile and portable high-capacity EV charging stations.

The NERD Box also networks the onboard camera systems and safety lighting systems, which not only provides security for the EV charging personnel, but also protects against vandalism and crime. The ingesting of this video feed data is also being utilized to enhance the charging experience by applying computer vision and with ML and AI which learns to detect charging issues from the facial and other human actions of EV charging personnel allowing for proactive onboard diagnostics to be run and remotely fix issues to provide increased uptime.

All of this data is securely uploaded to a cloud server and the online monitoring portal ‘e-Boost RealM’ (Realtime Monitoring) is passcode protected and accessible to assigned users and monitored 24/7 by live human service personnel who can escalate and engage appropriate personnel, if there are any system issues. e-Boost RealM automatically contacts propane providers for refueling via email or text messages, can initiate remote start of power generator in emergency situations and also repower onboard energy storage systems, if they run low in inclement weather situations.

Each of the mobile and portable high-capacity EV charging stations is delivered with an onboard safety helmet and safety glass set (“e-Boost AR”) that is integrated with augmented reality technology to be worn by any qualified local technician with minimal training that will automatically connect to our master technicians providing them with ‘remote eyes & ears’ and accurate guidance of any required equipment repairs. This type of technology saves time, cost and ensures maximum uptime of equipment for the mobile and portable high-capacity EV charging stations.

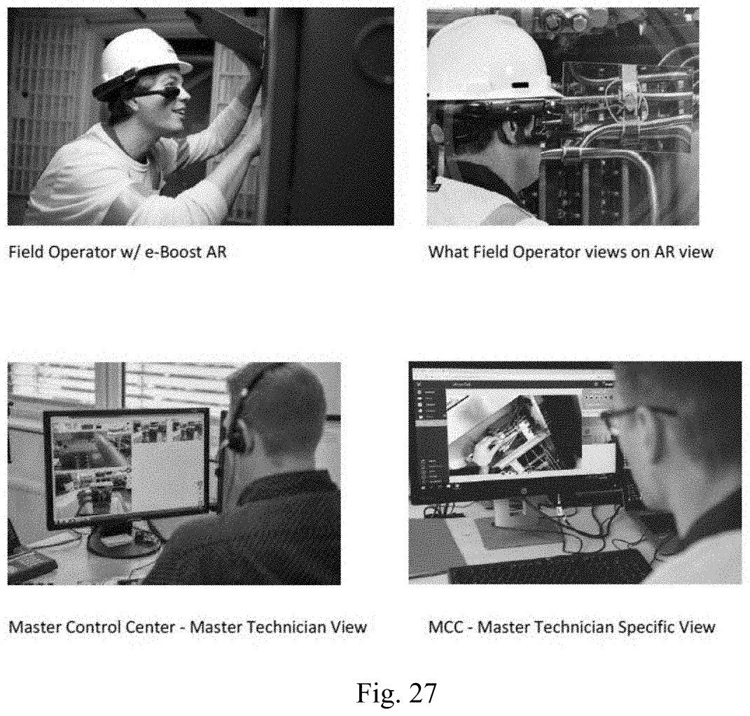

FIG. 27 shows examples of how this e-Boost AR is used.

The mobile and portable high-capacity EV charging stations are to be further developed to creating the smallest, mobile, combined DC power generator and EV charger that will address the ‘Uber-ization of Charging’ demand in the market for EV charging that is mobile, on-demand EV charging that is available through an app on phone at any time.

The concept of “the Last-Feet” is to be further developed. So, in EV charging, especially in places with adverse weather, the process of activating a charger and mating (hooking up) the charger dispenser to a vehicle can be cumbersome, time consuming and sometimes, very frustrating. Solving this will have enormous value, not just in EV charging, but in a lot of “Last-Feet” applications, especially for physically handicapped or disabled persons.

To accomplish this, one requires computer vision and autonomous maneuvering. With the continued development of the current onboard technology, in combination with other available open technologies, this “Last-Feet” charging solution is to be developed.

While the present invention has been described with reference to the preferred embodiments and modified examples, the present invention is not limited to the above-described specific embodiments and the modified examples, and it will be understood by those skilled in the related art that various modifications and variations may be made therein without departing from the scope of the present invention as defined by the appended claims.

What is claimed is:

1. A charging system for a mobile and portable high-capacity Electrical Vehicle (EV) charging station, the charging system comprising:
a plurality of propane tanks for generating power;
a generator;
an EV charger;
a voltage selector switch;
a plurality of solar panels for charging onboard batteries due to parasitic loads;
a communication backhaul;
a security device; and
a diagnostics and monitoring device for monitoring the plurality of tanks, the generator, and the EV charger.

2. The charging system according to claim 1, wherein the charging system is configured to be used in a plurality of platforms, the plurality of platforms comprising:
a skid;
a truck;
a trailer; and
a pod.

3. The charging system according to claim 1, wherein the charging system further comprises a software architecture capable of detecting where the charging system is at all times, diagnosing the charging system remotely, and processing advanced data analytics to improve performance.

4. The charging system according to claim 3, wherein the software architecture is built with the ability to augment computer vision using machine learning and AI (Artificial Intelligence).

5. The charging system according to claim 1, wherein the charging system further comprises an onboard data system through a NERD (Networked Electronic Resources Distribution) Box, which combines all of the necessary onboard electronics, advanced sensors, communication gateway, redundant data portals with cloud connectivity that is kept powered 24/7 through renewal solar energy and energy storage system,
wherein the onboard electronics connect all of the major systems within the charging system and ensures reliable communication between the plurality of propane tanks, the generator, the EV charger, the plurality of solar panels, the security device, and the diagnostics and monitoring device.

6. The charging system according to claim 5, wherein the advanced sensors comprise an ultrasonic propane tank level sensor that is noncontact, non-intrusive, accurately and reliably manages, monitors the level of propane fuel on board and is integrated with cloud connectivity, to automatically alert the nearest propane provider to ensure reliable delivery and refill the plurality of propane tanks.

7. The charging system according to claim 1, wherein even when a generator power is off, a user interface screen of the EV charger is active through an onboard parasitic power source and an electronic circuitry design.

8. The charging system according to claim 5, wherein the NERD Box networks onboard camera system and safety lighting systems for security protection.

9. The charging system according to claim 1, wherein all data is securely uploaded in a cloud server.

10. The charging system according to claim 1, wherein the charging system is configured to use either rLPG (renewable Liquid Petroleum Gas) or rDME (renewable Dimethyl Ether) for energy source.

11. The charging system according to claim 1, wherein the charging system is further extended to a multiple-way charging station, in which a plurality of EVs are charged simultaneously.
